(19) United States
(12) Patent Application Publication
(10) Pub. No.: US 2012/0272448 A1
(43) Pub. Date: Nov. 1, 2012

(54) RESISTIVE ACTUATION UNIT FOR TUB SYSTEMS

(76) Inventors: Dominique CIECHANOWSKI, Sainte-Marguerite-de-Dorchester (CA); Miguel Castellote, Sainte-Marguerite-de-Dorchester (CA)

(21) Appl. No.: 13/456,790

(22) Filed: Apr. 26, 2012

Related U.S. Application Data
(60) Provisional application No. 61/479,100, filed on Apr. 26, 2011.

(51) Int. Cl. A61H 33/02

(52) U.S. Cl. 4/546

(57) ABSTRACT

There is provided a resistive actuation unit for activating a tub system an operation of which is controlled by a controller. The actuation unit comprises at least one switching device coupled to a body of the tub and in communication with the controller. The switching device comprises a first and a second resistive element, each of which having a resistive value, which changes upon a contact being made on the resistive element. The controller detects a change in resistive value of at least one of the first and the second resistive element. If the controller detects a change in the resistive value of the first resistive element only, the selected function of the tub system is activated. Otherwise, the controller determines that water contacted the second resistive element and the selected function is not activated.

### CROSS-REFERENCE TO RELATED APPLICATION(S)

The present application claims priority on U.S. Application No. 61/479100, filed on Apr. 26, 2011, and incorporated herein by reference.

### FIELD OF THE APPLICATION

The present application relates to tubs having tub systems such as water massage systems (i.e., whirlpool systems), air-jet massage systems, aromatherapy systems, etc, and to an actuation unit for activating such tub systems.

### BACKGROUND OF THE ART

Tubs are well known for their primary use, namely a washroom installation in which a user person washes and bathes. Tubs have, however, evolved to add relaxation and comfort to practicality, and are found in many forms, such as bathtubs, spas, whirlpools.

For instance, tubs are now provided with air-jet systems and whirlpool systems, by which air or water is injected into the water of the tub to create some turbulence in the water. The turbulence creates a massaging effect on the bather in the tub. Other types of electrically actuated systems, such as oxygenation systems, foot-massage systems and aromatherapy systems are provided in conjunction with tubs, whereby a plurality of treatments and physical/sensorial experiences are available with tubs. Such systems are often actuated through mechanical switches with normally-open contacts, which contacts are closed by the manipulation of the user.

Other types of systems have been developed to avoid the use of mechanical contacts. For instance, systems using touchless or finger-sensitive technologies, which operate based on capacitive field fluctuation. One drawback with such systems is their sensitivity to dielectric liquids, whereby they do not constitute an efficient solution for tub applications.

The bather having recourse to such treatments or physical/sensorial experiences seeks amongst other things a moment of relaxation. It is therefore desired to simplify the use of all such systems to ensure that the bather benefits from relaxing in the tub.

### SUMMARY OF THE APPLICATION

It is therefore an aim of the present invention to provide a novel resistive actuation unit for tub systems.

In accordance with a first broad aspect, there is provided a tub comprising a body for holding a volume of water, a tub system coupled to the body and adapted to perform a function on the volume of water, at least one resistive switch mounted to a visible surface of the body and comprising at least one resistive element adapted to be contacted by a user, the at least one resistive element adapted to change resistive value upon being contacted, the change in resistive value of the at least one resistive element representative of a command from the user to activate the tub system; and a controller operationally coupled to the at least one resistive switch and to the tub system, the controller adapted to detect the change in resistive value of the at least one resistive element to activate the tub system according to the command.

Still in accordance with another broad aspect, there is provided resistive actuation unit for activating a tub system, the resistive actuation unit comprising: at least one resistive switch having at least one resistive element adapted to be contacted by a user and change resistive value upon being contacted, the change in resistive value of the at least one resistive element representative of a command from the user to activate the tub system; and a controller operationally coupled to the at least one resistive switch and to the tub system, the controller adapted to detect the change in resistive value of the at least one resistive element to activate the tub system according to the command.

Still in accordance with another broad aspect, there is provided method for activating a tub system coupled to a tub body holding a volume of liquid, the method comprising: monitoring a resistive value of at least one resistive element of at least one resistive switch mounted to a visible surface of the tub body; detecting a change in the resistive value, the change in resistive value of the at least one resistive element representative of a command to activate the tub system; and activating the tub system according to the command.

### BRIEF DESCRIPTION OF THE DRAWINGS

FIG. 1 is a schematic view of a tub with resistive actuation unit in accordance with an embodiment of the present disclosure, with a water detection sensor above piping;

FIG. 2 is a schematic view of a tub with resistive actuation unit in accordance with an embodiment of the present disclosure, with a water detection sensor in a bottom of the tub;

FIG. 3 is a schematic view of a tub with resistive actuation unit in accordance with an embodiment of the present disclosure, with a water detection sensor in piping;

FIG. 4 is side view of a resistive switch device in accordance with a first embodiment of the present disclosure;

FIG. 5 is side view of a resistive switch device in accordance with a second embodiment of the present disclosure;

FIG. 6 is a sectional view of a portion of the resistive switch device of FIG. 5; and

FIG. 7 is a schematic view of a circuitry of the resistive actuation unit of FIG. 3.

### DESCRIPTION OF THE PREFERRED EMBODIMENTS

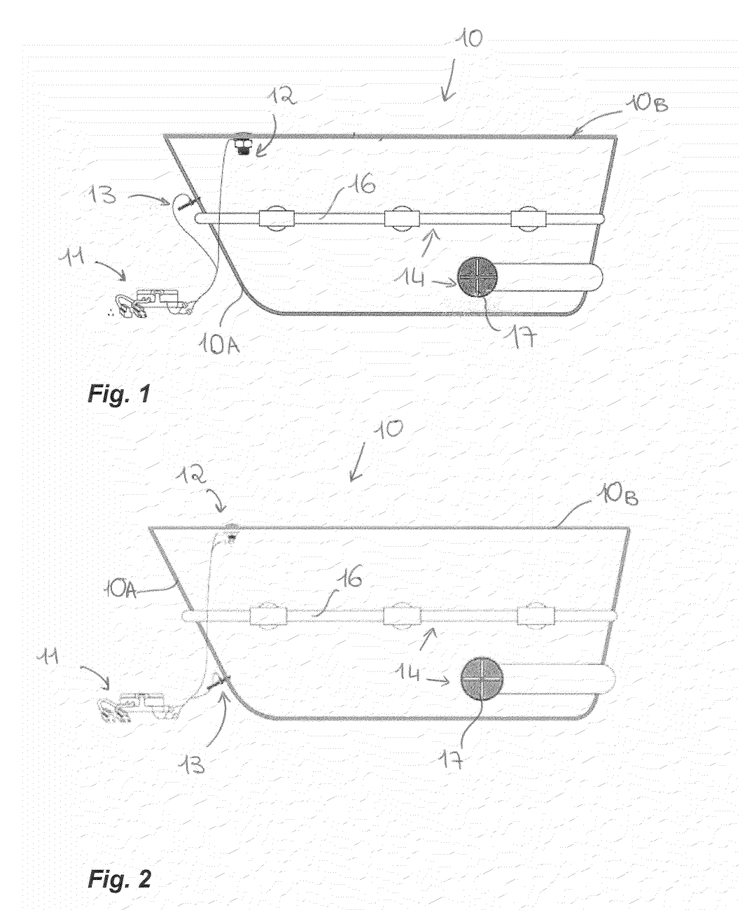

Referring to the drawings and more particularly to FIG. 1, a tub 10 is generally illustrated. A hidden or inner surface of the tub 10, comprising the tub wall 10A, is shown, although this surface is typically not visible once the tub 10 is installed. A visible or outer surface of the tub 10, comprising a flange 10B, is also shown. The tub 10 is equipped with a resistive actuation unit featuring a controller 11 that is electrically actuated. The controller 11 is connected to one or more resistive switch devices 12 to send an actuation signal to the controller 11. The controller unit 11 may also be connected to a water detection sensor 13, to determine whether a liquid (e.g., water) is present in the tub 10.

The controller 11 is used to operate a tub system 14. In the embodiment, the tub system 14 is a water jet system, by which water from the tub 10 is pressurized to be reinjected in the tub by jets. Alternative tub systems as in 14 may be used individually or in combination with the water jet system, such as air massage systems, oxygenation systems, foot-massage systems, chromotherapy systems, and aromatherapy systems, among numerous other possibilities. Accordingly, the functions or effects performed by the tub system 14 may comprise but are not limited to adjusting the temperature, the flow, and the pressure of the water, adjusting the pressure of the air injected in the water, modifying a scent diffused in the tub (in the case of aromatherapy systems), and modifying the lighting illuminating the tub (in the case of chromotherapy systems). In order to achieve various effects, a plurality of resistive switch devices 12 may thus be connected to the controller 11, each resistive switch device 12 being associated with a function of the tub system 14.

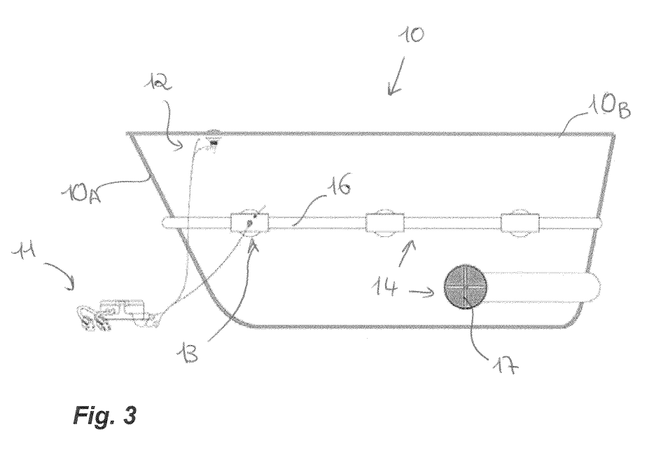

The controller 11 is therefore the interface between the user and the tub system 14, as it transmits actuation commands from the user to the tub system 14, to actuate or stop the tub system 14. Moreover, additional commands may be performed via the resistive actuation system, by providing additional resistive switch devices 12 (although not shown). Such additional commands include any appropriate function that may be performed by the tub system 14, and also the increase and decrease of the intensity of the effect performed by the tub system 14. The controller 11 may also perform safety functions, such as actuating the tub system 14 only when suitable operating conditions are met, such as the detection of water via the water detection sensor 13. Illustratively, if no water is detected by the water detection sensor 13 or the detected level of water is below a predetermined threshold, transmission by the user of an actuation command via the resistive switch devices 12 will not result in activation of the desired functions by the tub system 14. For that reason, as shown in FIG. 1, the water detection sensor 13 may be located directly in the tub wall 10A. It is observed that the water detection sensor 13 may be positioned above the piping 16 of the tub system 14 to ensure that the level of water in the tub 10 is above the piping 16. Alternatively, as shown in FIG. 2, the water detection sensor 13 may be positioned below the piping 16 yet above the level of an inlet 17 of the tub system 14. Also, as illustrated in FIG. 3, the water detection sensor 13 may be located in the piping 16 of the tub system 14, to ensure that the level of water in the tub 10 is at the level of the piping 16 or above.

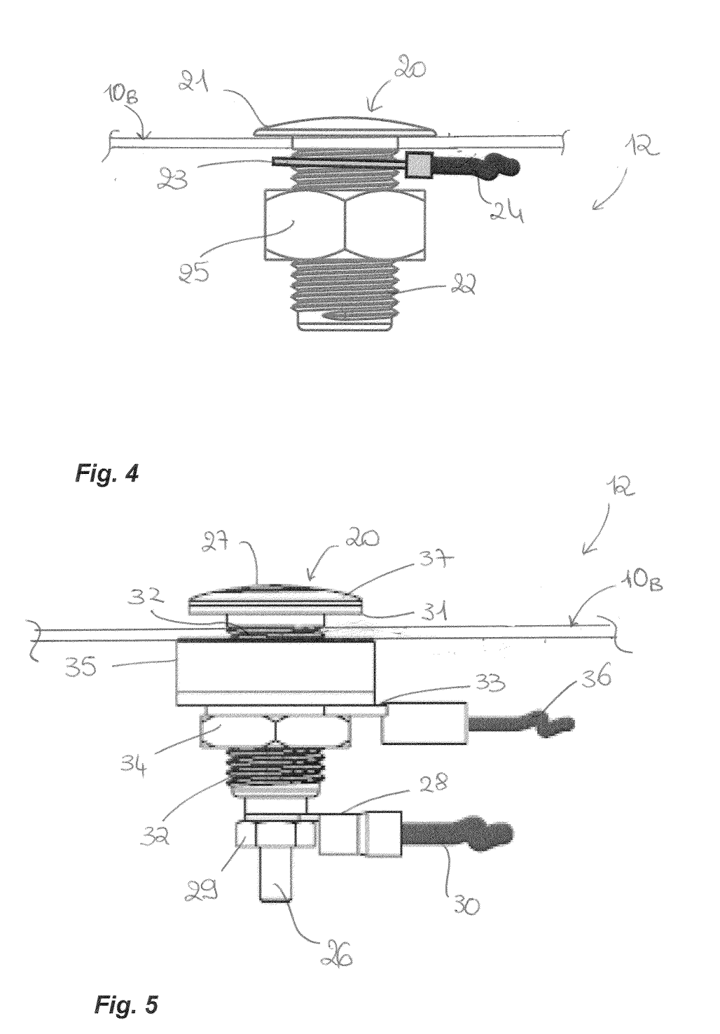

Referring to FIG. 4, one of the resistive switch devices 12 in accordance with a first illustrative embodiment will now be described. The switch device 12 comprises a first resistive element 20 comprising a head portion 21, which may be exposed on a visible face of the flange 10B of the tub 10. The head portion 21 may be provided with a shape, such as a pushbutton shape, suitable for actuation thereof by the user. The head portion 21 may be further provided with indicia or logo, drawn, etched, or otherwise presented thereon, which is indicative of the function that will be performed when a user presses the switch device 12.

The resistive element 20 may also comprise a bottom portion 22, which may feature threading thereon. A connector 23 may be coupled to the bottom portion 22 and is adapted to be connected to the controller 11 by a wire 24 or any other suitable means. The connector 23 may be an eyelet connector or any other appropriate connector known to those skilled in the art. A nut 25, which may feature thereon tapping adapted to threadingly engage with the threading provided on the bottom portion 22, may be coupled to the bottom portion 22 for maintaining the connector 23 in contact with the head portion of the resistive element 20. Any appropriate connection configuration may be used to ensure that the connector 23 remains in contact with the bottom portion 22, and that the resistive element 20 remains secured to the tub wall 10A (e.g., adhesives, mating engagement, etc).

In operation, the resistive element 20 may be positioned on the flange 10B of the tub 10 by inserting the bottom portion 22 in a hole (not shown) machined or manufactured in the flange 10B. When in place, the head portion 21 of the resistive element 20 illustratively rests on a visible face of the flange 10B of the tub while the bottom portion 22 projects into an underside of the tub 10. The connector 23 may then be coupled to the bottom portion 22 in abutment with a hidden face of the flange 10B. The nut 25 may be coupled to the bottom portion 22 in abutment with the connector 23 to secure the latter in place. The connector 23 may further be connected to the controller 11 via the wire 24 and a current may circulate in the resistive element 20 via the wire 24. The contact of a finger or like body part on the head portion 21 of the resistive element 20 may in turn modify the resistive value of the resistive element 20 detected by the controller 11, thereby identifying a command from a user.

Referring to FIG. 5 in addition to FIG. 4, since the head portion 21 of the first resistive element 20 may be exposed on the visible face of the flange 10B, the first resistive element 20 may be sensitive to the contact of water. As such, the controller 11 may falsely identify a command when water is in contact with the head portion 21 of the resistive element 20. In order to prevent inadvertent activation of the tub system 14 due to water accidentally contacting the first resistive element 20 without the user contacting the latter, a second resistive element may therefore be provided in electrical insulation with the first resistive element 20. In this manner, it may be possible to discriminate between user activation of the resistive switch device 12 and water contacting the resistive switch device 12. However, in some applications, for instance in which the switch device 12 is minimally exposed to water, the use of a single resistive element suffices.

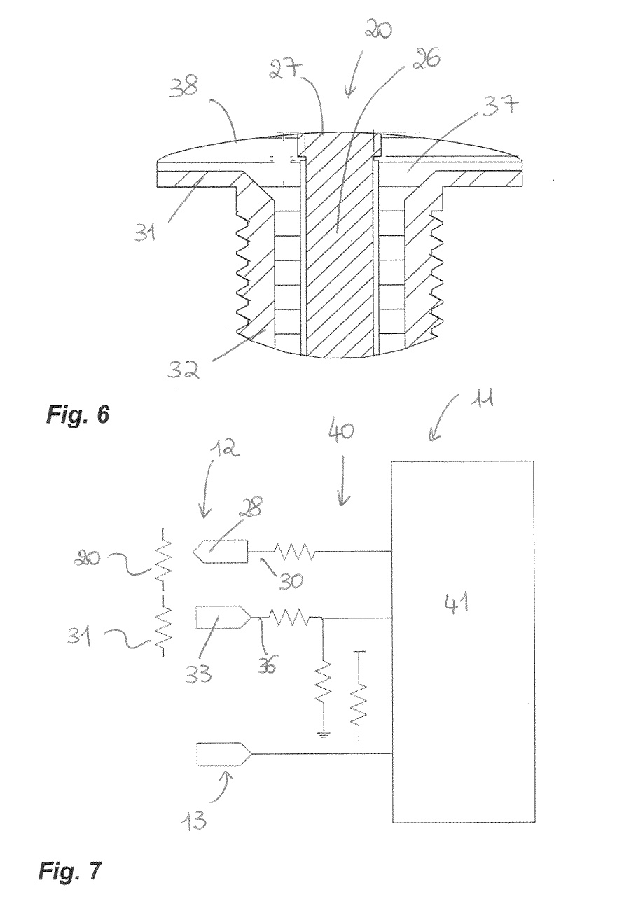

Referring concurrently to FIGS. 5 and 6, according to a second illustrative embodiment, the first resistive element 20 may have a slender rod 26, having an exposed tip portion 27, being exposed on the visible face of the flange 10B of the tub 10. A bottom of the rod 26 of the element 20 projects into an underside of the tub 10, and may feature threading thereon. An eyelet connector 28 (or any other appropriate connector) is maintained in contact with the rod 26 by way of nut 29, or by any appropriate connection configuration (e.g., fastener, glue, magnets, etc.). The connector 28 is connected to the controller 11 by wire 30, through which a current circulates to modify the value of the resistive element 20 detected by the controller 11 in the event of a user contacting the tip portion 27.

A second resistive element is illustratively provided and comprises a ring portion 31 that is exposed on the visible face of the flange 10B of the tub 10. A sleeve 32 is in conductive relation with the ring portion 31. The sleeve 32 may comprise threading, as shown in FIGS. 5 and 6.

A connector 33 is in contact with the outer surface of the sleeve 32 and is maintained in the illustrated position by way of a nut 34, or by any appropriate connection configuration (e.g., fastener, glue, magnets, etc.).

A sealing ring 35 is positioned about the sleeve 32 in abutment with the hidden face of the flange 10B. The sealing ring 35 seals the hole in the tub 10 through which passes the sleeve 32. Nut 34 is used to press the sealing ring 35 against the hidden face of the flange 10B of the tub 10. The connector 33 is connected to the controller 11 by wire 36. Although not shown, the resistive switch device 12 of FIG. 4 may have a similar sealing arrangement, with a sealing ring 35 and fastener.

An insulating spacer 37 connects the first resistive element 20 to the second resistive element 31/32. The insulating spacer 37 is illustratively a T-shaped member with an inner channel accommodating part of the rod 26. Moreover, the sleeve 32 houses a portion of the spacer 37, as shown in FIG. 6. The insulating spacer 37 has a head portion 38. The head portion 38 is typically provided with an appropriate indicia or logo to indicate the function that will be performed when pressing the resistive switch device 12. Alternatively, the indicia or logo may be on the tip portion 27 of the first resistive element 20. In an embodiment, the periphery of the ring portion 31 does not extend radially beyond a periphery of the head portion 38. Accordingly, from a top plan view, the ring portion 31 is fully concealed under the head portion 38, as observed from FIG. 6.

Accordingly, a current circulates in the second resistive element via the wire 36, and the contact of water on the ring portion 31 will modify the resistive value of the second resistive element detected by the controller 11, thereby the presence of water.

Therefore, in operation, a change in resistive value of both the first and second resistive elements 20 and 31/32, or of the second resistive element 31/32 only (and not to the first resistive element 20), will indicate to the controller 11 that water is in contact with the resistive switch device 12, whereby the controller 11 will not perform any operation. A change in resistive value of the first resistive element 20 only (and not to the second resistive element 31/32) will indicate to the controller 11 that contact is selectively made with the resistive switch device 12, whereby the controller 11 will perform the appropriate function. Moreover, the water detection sensor 13 may operate in similar resistive fashion. In such a case, the controller 11 would need to detect the presence of liquid in the tub 10 via a variation in the resistive value of the sensor 13, as discussed herein above.

As shown in FIG. 7, a contemplated circuitry 40 and micro-processor 41 are shown, as used by the controller 11 to operate the resistive switch device 12. It is pointed out that any appropriate circuitry may be used as well and that switch devices 12 other than resistive may be used, as will be apparent to a person skilled in the art. However, considering that water is in the proximity of the resistive actuation unit, all necessary precautions must be taken to avoid any electrical shock. The use of resistive actuation is appropriate in that low current and low voltage are sufficient to operate the switch devices 12. Nevertheless, any appropriate safety circuit and ground must be present in the controller 11.

1. A tub comprising:
a body for holding a volume of water;
a tub system coupled to the body and adapted to perform a function on the volume of water;
at least one resistive switch mounted to a visible surface of the body and comprising at least one resistive element adapted to be contacted by a user, the at least one resistive element adapted to change resistive value upon being contacted, the change in resistive value of the at least one resistive element representative of a command from the user to activate the tub system; and
a controller operationally coupled to the at least one resistive switch and to the tub system, the controller adapted to detect the change in resistive value of the at least one resistive element to activate the tub system according to the command.

2. The tub of claim 1, wherein the at least one resistive element comprises a first resistive element and a second resistive element insulatively coupled to the first resistive element, a change in resistive value of the first resistive element representative of the command and a change in resistive value of the second resistive element representative of a contact of the water on the at least one resistive switch.

3. The tub of claim 2, wherein the controller is adapted to detect the change in resistive value of at least one of the first and the second resistive element and to activate the tub system according to the command if a change in resistive value is detected in the first resistive element only.

4. The tub of claim 2, wherein the first resistive element comprises a rod having a first end portion exposed on the visible surface of the body and a second end portion projecting into an underside of the body.

5. The tub of claim 4, wherein the second resistive element comprises a ring insulatively to the first end portion of the rod so as to be exposed on the visible surface of the body.

6. The tub of claim 5, wherein the second resistive element further comprises a sleeve coupled to the second end portion of the rod in conductive relation with the ring.

7. The tub of claim 6, further comprising an insulating spacer housed in the sleeve and having an inner channel accommodating the rod therein, thereby insulatively coupling the first and second resistive elements.

8. The tub of claim 7, wherein the insulating spacer comprises a head portion exposed on the visible surface of the body.

9. The tub of claim 6, wherein the visible surface of the body comprises a flange and further wherein the at least one resistive switch is received in a hole formed in the flange with the ring in abutment with a visible face of the flange.

10. The tub of claim 9, further comprising a sealing ring positioned about the sleeve in abutment with a hidden face of the flange for sealing the hole.

11. The tub of claim 1, further comprising a water detection sensor mounted to the body for detecting liquid in the body above a given level, wherein the controller activates the tub system in response to the change in resistive value if liquid is detected by the detection sensor.

12. The tub of claim 1, wherein the at least one resistive switch comprises a plurality of resistive switches each associated with a corresponding one of a plurality of functions of the tub system.

13. A resistive actuation unit for activating a tub system, the resistive actuation unit comprising:
at least one resistive switch having at least one resistive element adapted to be contacted by a user and change resistive value upon being contacted, the change in resistive value of the at least one resistive element representative of a command from the user to activate the tub system; and
a controller operationally coupled to the at least one resistive switch and to the tub system, the controller adapted to detect the change in resistive value of the at least one resistive element to activate the tub system according to the command.

14. The resistive actuation unit of claim 13, wherein the at least one resistive switch comprises a first resistive element and a second resistive element operationally coupled to the first resistive element, a change in resistive value of the first resistive element representative of the command and a change in resistive value of the second resistive element representative of a contact of the water on the resistive switch, and wherein the controller is adapted to detect the change in resistive value of at least one of the first and the second resistive element and to activate the tub system according to the command if a change in resistive value is detected in the first resistive element only.

15. The resistive switch of claim 14, further comprising an insulating spacer for insulatively coupling the first and second resistive elements.

16. A method for activating a tub system coupled to a tub body holding a volume of liquid, the method comprising:
monitoring a resistive value of at least one resistive element of at least one resistive switch mounted to a visible surface of the tub body;
detecting a change in the resistive value, the change in resistive value of the at least one resistive element representative of a command to activate the tub system; and
activating the tub system according to the command.

17. The method of claim 16, wherein the detecting a change in resistive value of the at least one resistive element comprises detecting a change in resistive value of at least one of a first resistive element and a second resistive element operationally coupled to the first resistive element.

18. The method of claim 17, wherein the activating the tub system according to the command comprises activating the tub system according to the command if the change in resistive value is detected in the first resistive element only.

19. The method of claim 17, further comprising determining a contact of the liquid on the at least one resistive switch if a change in resistive value is detected in the second resistive element.

20. The method of claim 16, further comprising receiving from a water detection sensor a detected presence of liquid above a given level in the body, wherein the activating the tub system comprises activating the tub system if liquid is detected by the water detection sensor.
